(19) United States
(12) Patent Application Publication
(10) Pub. No.: US 2006/0243781 A1
(43) Pub. Date: Nov. 2, 2006

(54) Postcard with integral photo frame and method for making the postcard

(75) Inventor: Patrick Simpson-Jones, Key Biscayne, FL (US)

Correspondence Address: GREGORY L. MAYBACK, P.A., 5722 S. FLAMINGO ROAD #232, FORT LAUDERDALE, FL, 33330, US

(73) Assignee: Simber, Inc.

(21) Appl. No.: 11/408,386

(22) Filed: Apr. 21, 2006

Related U.S. Application Data
(60) Provisional application No. 60/676,194, filed on Apr. 29, 2005.

(51) Int. Cl. B42D 15/00; B65D 27/04; A47G 1/06

(52) U.S. Cl. 229/92.8; 229/71; 40/775

(57) ABSTRACT

A postcard includes a generally planar body having a front face and a rear face together defining an interior adapted to receive and hold a photographic print. A windowpane can be disposed between the front and rear faces to protect the photograph from the environment. The rear face has a greeting area, an address area, a postage area, and a stand extendible from the greeting area and operable to permit the postcard to be stood on its side without obstructing the greeting area. The front face has a removable part for keeping the photograph hidden from view until a user removes the part. The removable part is connected to the front body in a breakable connection and, when removed, can form an advertisement, a coupon, and/or a single-sheet postcard. A perfume sample holding device can be connected to any part of the postcard.

### CROSS-REFERENCE TO RELATED APPLICATION

This application claims the priority, under 35 U.S.C. § 119, of U.S. Provisional Patent Application No. 60/676,194 filed Apr. 29, 2005, the entire disclosure of which is incorporated herein by reference in its entirety.

### BACKGROUND OF THE INVENTION

1. Field of the Invention

The present invention relates to a postcard formed from a generally planar sheet of card or stiff paper, the postcard having an integral stand on one side, a pocket for receiving a photo therein, and a photo frame on the other side having a removable face for concealing the photo until the face is removed.

2. Description of the Related Art

A typical postcard has a front face and a rear face. On the front face is a picture relating to the place from which it is sent, for example. The reverse face includes a location for receiving a greeting written by the sender, a location for receiving a stamp thereon, and a location for receiving an address of the intended recipient. Typical postcards are rectangular, having two parallel long sides and two parallel short sides. Once received and read, this type of card serves no further purpose. Frequently the card is simply discarded. Alternatively, the card may be secured to a notice board using a pin.

A postcard different from the prior art is embodied in U.S. Pat. No. 5,855,396 to Simpson-Jones et al. (hereinafter “Simpson”). The first-named inventor of Simpson is the inventor of the present invention. The Simpson postcard is described in the following text.

The Simpson postcard has a planar body with a front face to which a picture has been applied or adapted for the application of a picture. The Simpson postcard also has a stand extendible from a reverse face of the planar body and operable to permit the planar body to be stood on its side. This card is adapted to be personalizable by the application of a picture in the form of a photographic print. Once received thereon, the card may be displayed using the stand and without needing to fix the card to any other surface, e.g., a notice board. The postcard can have any polygonal shape and may, therefore, have a corresponding plurality of sides.

A reverse face of the planar body includes an address portion for the indication of an address of a recipient of the postcard. Significantly, the stand extends from the address portion. As such, even with the stand extended, a reader is still able to read the greeting written on the reverse face of the card in the remaining area of that face not forming the address portion.

The stand has a flap defined in the reverse face by lines of weakness formed in the reverse face. One of the lines of weakness forms a fold line for folding the flap out of the plane of the planar body that, when so folded, forms an extending portion upon which the postcard rests when the planar body is stood on its side. The lines of weakness not forming a fold line are formed by perforation of the reverse face. Such a configuration permits the flap to be detached from the reverse face along these two perforated lines. The flap is generally triangular. Therefore, with two triangular flaps, each triangular flap is foldable to form a respective extending portion for standing the card on a respective one of a long and a short side of the planar body. The two triangular flaps define, in combination, in the reverse face a generally rectangular shape having a diagonal line of weakness forming a common side of the two flaps. This generally rectangular shape may correspond to the address portion of the reverse face. Accordingly, the number of lines of weakness that must be formed is reduced.

To form the stand, the planar body may have two substantially coextensive layers, the flap or flaps of the stand being defined in the rear one of the layers with the other layer forming the front face.

FIG. 1 illustrates a rear face of the Simpson postcard 2. The rear face has an address portion 4, an area for placing a stamp 6, and an area for writing a greeting 8. In the address portion 4, two triangular flaps 10, 12 are formed by lines of weakness 14, 18, 16, 20 and a common diagonal line of weakness 22.

The lines of weakness 18, 20, 22 are formed by perforating the material of the postcard and permit the triangular flaps 10 and/or 12 to be detached from the rear face 2 and folded out of the plane of the drawing and out of the plane of the rear face 2 along fold lines 14 and 16 respectively. The Simpson postcard 2 has two layers, the flaps 10, 12 being formed only in the rearmost layer.

FIGS. 2 and 3 show the triangular flaps 10 and 12 respectively folded as described above. In the folded position, the triangular flaps 10, 12 form extending portions that permit the planar body of the card 2 to be stood on its side. The thickness of the material (typically cardboard) from which the flaps are formed is chosen to ensure that the flaps do not bend under the weight of the postcard 2. The two extending portions 10, 12 allow the planar body of the postcard 2 to be stood on its long and short sides, respectively.

The face of the Simpson postcard 2 (hidden in FIGS. 1 to 3) is adapted to receive a photographic print or is printed with a suitable picture as in postcards previously known in the art.

By adopting the two-layer construction described above, the flaps 10, 12 may be folded out from the rear of the postcard 2 without disturbing an image printed on the front face of the card. Similarly, the two-layer construction permits the flaps 10, 12 to be folded out without disturbing any adhesive connection between a photographic print and the postcard 2.

With respect to connection of the photo to the postcard 2, the Simpson postcard 2 has the photograph printed on the front side, applied to the front side, or placed beneath a protective, self-adhesive, transparent plastics layer located on the front side to securely hold the photo beneath the plastics layer.

If the front face of the postcard is adapted for the application of a photographic print beneath the protective, self-adhesive, transparent plastics layer, the card can be personalized by the inclusion of a photograph. Also the layer beneath the plastics layer can be self-adhesive so that the photographic print is securely held beneath the plastics layer. The adhesive used on the plastics layer combines chemically with the upper surface finish of the photographic print to ensure that the photographic print is clearly visible through the plastics layer. This postcard configuration, however, has a disadvantage in that anyone holding the card can see the photograph. In other words, there is no measure of privacy provided by the postcard described in U.S. Pat. No. 5,855,396 to Simpson-Jones et al.

Accordingly, it would be beneficial to provide measures to allow the photograph to be hidden from view until desired by the ultimate user. It would also be beneficial to provide the hiding device with beneficial features prevent or delay the disposal of the hiding device when removed.

### SUMMARY OF THE INVENTION

The present invention improves upon prior art postcards by adding a privacy feature on the front face at which a picture can been applied so that the picture is not seen until the recipient desires to open the front face.

With the foregoing and other objects in view, there is provided, in accordance with the invention, a postcard, including a generally planar rear body having a front face, a rear face, at least two edges, and a stand extendible from the rear face to permit the rear body to be stood on either of the edges, a generally planar front body having a forward face, a reverse face, at least two edges, and a removable part, the rear body and the front body being connected together to define a pocket therebetween for receiving and holding a third planar body therein, the third planar body being smaller than at least one of the rear body and the front body, and the front body defining a window for viewing the third planar body when the removable part is at least partially removed from the front body.

With the objects of the invention in view, there is also provided a postcard, including a generally planar rear body, a generally planar front body having a removable part, the front body being connected to the rear body to define a pocket therebetween for receiving and holding a third planar body therein, the third planar body being smaller than at least one of the rear body and the front body, and the front body defining a window for viewing the third planar body when the removable part is at least partially removed from the front body.

With the objects of the invention in view, there is also provided a postcard, including a generally planar rear body, a generally planar front body having a removable part, the front body being connected to the rear body to define a pocket therebetween for receiving and holding a third planar body therein, the third planar body being smaller than at least one of the rear body and the front body, the front body defining a window for viewing the third planar body when the removable part is at least partially removed from the front body, and an at least partially transparent, generally planar window body disposed between the front and rear bodies for protecting the third planar body disposed between the front and rear bodies from the environment.

In accordance with another feature of the invention, the stand has two flaps defined in the rear face by lines of weakness formed in the rear face, two of the lines of weakness forming fold lines for folding at least one of the flaps out of a plane of the rear body to form a respective extending portion upon which the rear body rests when the rear body is stood on one of the edges

In accordance with a further feature of the invention, the two flaps are two triangular flaps, each of the triangular flaps folding to form a respective one of the extending portions for standing at least the rear body on one of the edges.

In accordance with an added feature of the invention, there is provided an at least partially transparent, generally planar window body disposed between the front and rear bodies for protecting the third planar body disposed between the front and rear bodies from the environment.

In accordance with an additional feature of the invention, the window body is connected to the reverse face of the front body to form a protective enclosure at the window.

In accordance with yet another feature of the invention, the rear face has a first portion for positioning thereon a postal address and a second portion for receiving a message thereon.

In accordance with yet an added feature of the invention, the flaps have a common line of weakness.

In accordance with yet an additional feature of the invention, the removable part is an entirely separate part from a remainder of the front body, is located in the front body, and is removably connected to the windowpane.

In one exemplary alternative configuration of the postcard, instead of an adhesive backing on removable part, the removable portion can have no adhesive and merely be dry lifted for removal. In such a case, tearing portions can hold the part in place.

In a further exemplary alternative configuration, any kind of media or device can be removably or fixedly secured to the postcard. For example, a perfume sample holding device can be placed on the removable part or any other portion of the postcard.

In accordance with again another feature of the invention, the removable part is connected to the front body in a breakable connection.

In accordance with again a further feature of the invention, the removable part has breaking tabs removably connecting the removable part to the front body.

In accordance with again an added feature of the invention, the breaking tabs are 8 breaking tabs.

In accordance with again an additional feature of the invention, the removable part is, when removed, an advertisement.

In accordance with still another feature of the invention, the removable part is, when removed, a coupon.

In accordance with still a further feature of the invention, the removable part is, when removed, a single-sheet postcard.

In accordance with still an added feature of the invention, there is provided a perfume sample holding device connected to at least one of the rear body, the front body, and the removable part.

In accordance with still an additional feature of the invention, the perfume sample holding device has a removable tab that, when removed, exposes a perfume sample to the environment.

In accordance with a concomitant feature of the invention, the front body has a rear face and the window body is connected to the rear face to form a protective enclosure at the window.

Other features that are considered as characteristic for the invention are set forth in the appended claims.

Although the invention is illustrated and described herein as embodied in a postcard with integral photo frame and method for making the postcard, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a plan view of a rear face of a postcard according to the prior art;

FIG. 2 is a perspective view of the postcard of FIG. 1 with a first portion of a stand in an open position and the postcard resting on a long side thereof;

FIG. 3 is a perspective view of the postcard of FIG. 1 with a second portion of the stand in an open position and the postcard resting on a short side thereof;

FIG. 4 is an exploded view of an exemplary embodiment of a postcard according to the invention; and

FIG. 5 is a plan view of a rear body of the postcard of FIG. 4 viewed from a front side thereof.

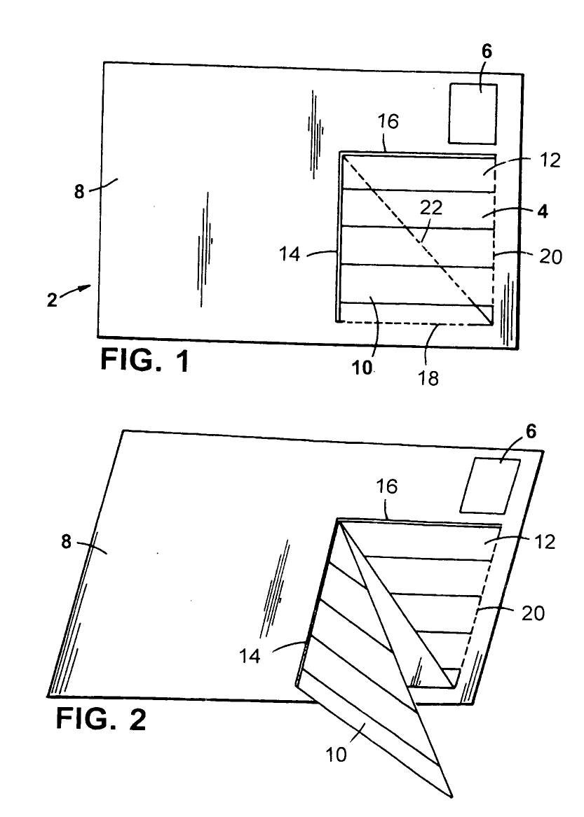

### DESCRIPTION OF THE PREFERRED EMBODIMENTS

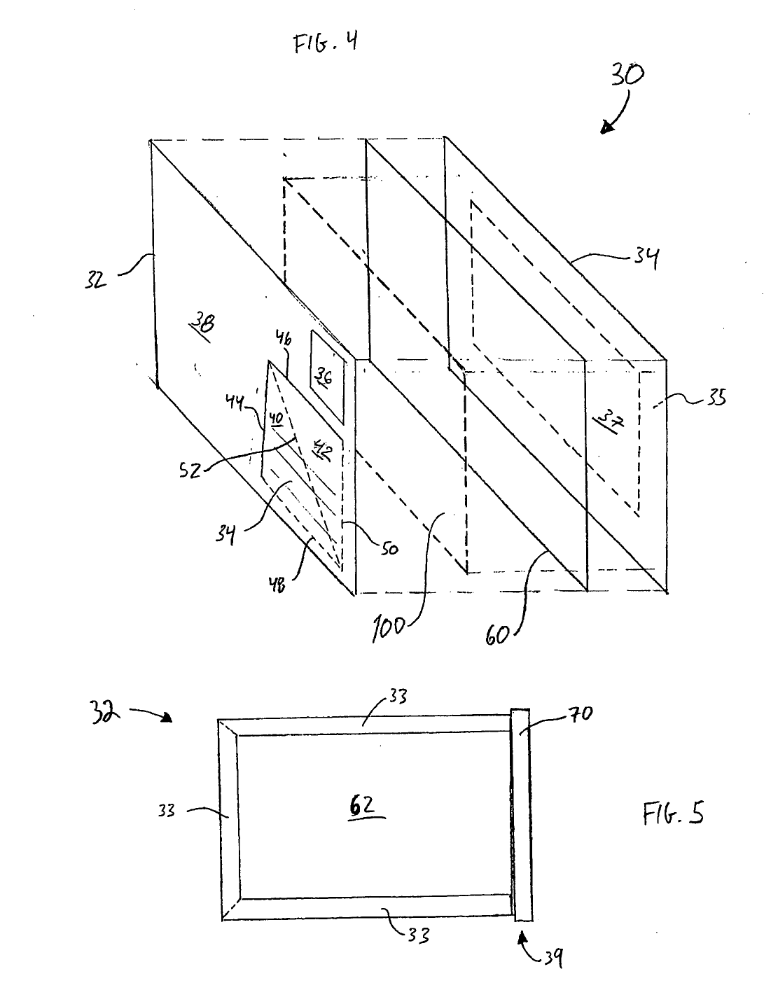

Referring now to the figures of the drawing in detail and first, particularly, to FIG. 4, an exemplary embodiment of the postcard 30 according to the present invention is shown in exploded form.

The postcard 30 has a rear body 32 and a front body 34. The rear body 32 has an address portion 34, an area for placing a stamp 36, and an area for writing a greeting 38.

In the address portion 34, two triangular flaps 40, 42 are formed by lines of weakness 44, 46, 48, 50 and a common diagonal line of weakness 52.

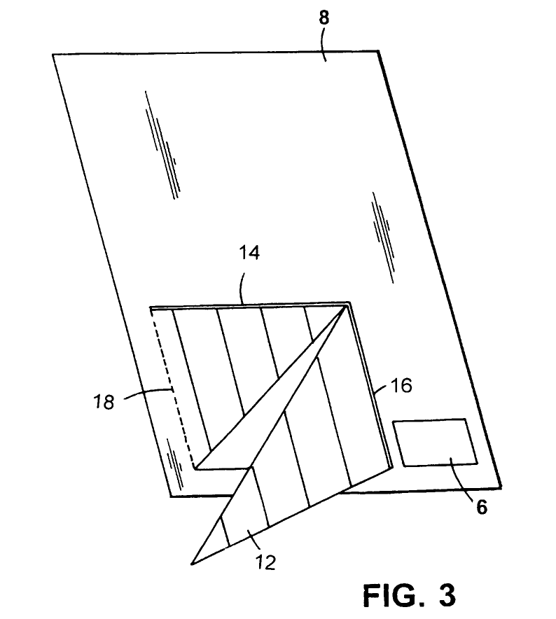

The lines of weakness 48, 50, 52 are formed by perforating the material of the rear body 32 to permit either or both of the triangular flaps 40 and 42 to be detached from the rear body 32 and folded out of the plane of the rear body 32 along fold lines 44 and 46, respectively. In a folded position, the triangular flaps 40, 42 form extending portions that, as shown in FIGS. 2 and 3, permit the planar body of the postcard 30 to be stood on a side thereof. In an alternative embodiment without the stand, the address portion 34 does not include these lines of weakness.

FIG. 4 illustrates the relationship between the rear body 32, the front body 34, an optional clear windowpane 60, and a photographic print 100 that is to be displayed from the front side 35 of the front body 34 and is to be held between the rear and front bodies 32, 34.

The front body 34 contains a removable part 37 that is demarcated by lines of weakness or that is entirely separate from the exterior of the front body 34. In either case, the user has the ability to pull away the removable part 37 and, thereby, separate it from the front body 34, leaving an opening in the front body 34 for viewing the photographic print 100. Alternatively, three sides of the removable part 37 can be lines of weakness and one side of the removable part 37 can be integral with the front body 34 and, therefore, forms a fold line. In such a configuration, the removable part 37 becomes a removable flap or door that can be selectively closed and opened.

With the aforementioned features, the postcard 30 according to the present invention improves upon the front side of prior art postcards by allowing the photographic print 100 to be hidden from view until the removable part 37 of the front body 34 is detached or opened by a user.

If a transparent windowpane 60 is not included between the rear and front bodies 32, 34, then, when the removable part 37 is removed, a user will be able to physically touch the print 100. Fingerprints can mar a viewing surface of the print 100. Accordingly, it is desirable to place the windowpane 60 in between the rear and front bodies 32, 34. The windowpane 60 can serve a second purpose—to secure the removable part 37 before being removed from the front body 34. For example, the rear side of the removable part 37 can have non-permanent adhesive that allows it to stick to the front, viewing side of the windowpane 60. Then, when a user decided to remove the part 37, force is applied to one edge or corner and the part 37 is peeled away to leave a clear, unmarred window behind, which allows the photograph 100 to be seen but not touched.

The windowpane 60 can have an area that is at least as large as the removable part 37. In the preferred embodiment shown in FIG. 4, the windowpane 60 has an area equal to the front body 34 and the front body 34. However, the dimensions of the pane 60 can be anywhere in between.

The removable part 37 is shown in FIG. 4 as having a non-permanent adhesive on the rear side thereof (opposite front side 35) to permit easy removal and the remainder of the rear side of the front body 34 has either a permanent or non-permanent adhesive. In such a configuration, the rear body 32 does not need to be fastened to any part of the front body 34 and only needs to be secured to the windowpane 60. (This is not necessarily true if the windowpane 60 has a smaller area than the front body 34.)

Instead of an adhesive backing on the removable part 37, the removable part 37 can be connected to the front body in a dry lifting manner. As set forth herein, a “dry lift removable part” is a part that does not have adhesive to connect it to any other part of the postcard 30. For example, the dry lift part 37 can have small contact point, e.g., one or two per side, that fixedly connects the dry lift part 37 to the frame of the front body 34. Such contact points can be created by forming the part 37 by cuts in the front body 34 with only small connections left remaining. To remove the dry lift part 37 from the front body 34, all that is needed is a small lifting force that is greater than the force holding the two parts 34, 37 together at the contact points.

With the removable part 37 not having adhesive, the removed card 37 can act as a separate device. For example, it could be a coupon entitling the bearer to some benefits or discounts, it could be an advertisement or contain advertising materials, or it can be a separate postcard that can be sent by the user to the post-a-photo sender. In the latter case, a pre-paid postcard-mailing fee could be included.

In the configuration where the removable part 37 does not have adhesive, any kind of media or device can be removably or fixedly secured to the inside side of the part 37. For example, a perfume sample holding device can be placed on the inside surface of the part 37 with a removable tab covering the perfume until the user desires to sample the perfume, if at all. Of course, such a perfume sample holder can be placed anywhere on the postcard where there is sufficient room and location at the inside surface of the part 27 is not exclusive.

In the configuration where the removable part 37 has the non-permanent adhesive on the rear side thereof, the postcard 30 can be accompanied by an entirely separate, non-illustrated card having the same dimensions as the removable part 37. Thus, when the removable part 37 is removed from the postcard 30, it can be fastened to the separate card in a relatively permanent connection. One exemplary embodiment of the separate card/removable part 37 combination has the surface opposite the one to be fastened to the removable part 37 include postcard indicia, such as the postage stamp area and the address area (see rear body 32 in FIG. 4), so that the combination of the removable part 37 and the separate card can create a postcard—to be mailed to a third party, for example, as a thank you for receiving the framed photo.

The rear body 32 is connected to the windowpane 60 in various ways. The preferred embodiment has the rear body 32 permanently connected on all but one side thereof. For example, for a rectangular print 100 and a rectangular body 32, 34, the rear body 32 is permanently connected to the windowpane 60 on three sides. This configuration leaves a single slot or opening for inserting the print 100 in between the rear body 32 and the pane 60. The fourth side can have no adhesive and, therefore, the print 100 can be taken out and replaced by another at the desire of the user. Alternatively, because the front body 34 forms a frame surrounding the print 100 when the removable part 37 is detached, the user can desire to have a more permanent connection at the fourth side. In such a case, either the rear body 32 or the windowpane 60 (or even the front body 34 if pane 60 has an area<front body 34) can have a permanent adhesive strip covered by a removable, non-permanently-connected tear-off tab 70.

A preferred configuration for this embodiment has the front body 34 permanently connected to the windowpane 60 and the removable part 37 non-permanently connected to the windowpane 60. In this embodiment, the front body 34 and the windowpane 60 have the same shape and area, in particular, they are rectangular. The preferred form for the rear body 32 is shown in FIG. 5 and has three adhesive areas 33 or a single U-shaped adhesive area 33. Thus, when the windowpane 60 is lined up and pressed against the rear body 32, the two parts 32, 60 become permanently connected to one another and form a pocket 62 having an entrance for receiving a print 100 at an opening side 39 (the right side of the rear body shown in FIG. 5). If there is no adhesive on the opening side 39, then the print 100 can be inserted and removed from the pocket 62 at the discretion of the user.

However, the preferred configuration of the opening side 39 allows the entrance to the pocket 62 to be permanently closed by removing the tear-off tab 70 to expose adhesive therebeneath. In such a condition, the print 100 is secured in the postcard 30 and protected therein from the environment. Further, the print 100 cannot be viewed by anyone until the removable part 37 is removed.

To form such a permanent connection on the opening side 39, first, a layer of adhesive is placed thereon and is, thereafter, covered by the pull-off tab 70. The pull-off tab 70 is made from a material that connects to the adhesive but does not permanently bond thereto. Accordingly, the tab 70 can be removed from the opening side 39 at the discretion of the user. Preferably, the tab 70 extends beyond the outer boundaries of the adhesive at the opening side 39, in particular, extends past the edges of the rear area 32 in a longitudinal direction of the opening side 39. In such a configuration, the tab 70 can be grasped easily by a user and torn off at any time. When so removed, subsequent contact between the opening side 39 and the windowpane 60 will result in a permanent connection that closes off the pocket 62 holding the print 100.

A process for creating the postcard 30 of the present invention includes providing the rear body 32 with the address portion 34, the stamp area 36, and the greeting area 38 on a rear face thereof. Lines of weakness 48, 50, 52 are formed at the address portion 34 such that at least one flap 40, 42 is formed for standing the rear body 32 on a side thereof after the flap 40, 42 is extended from the rear body 32.

At least one edge of a front face of the rear body 32 (opposite the rear face) has placed thereat a fastener. In the preferred embodiment, the fastener is a substance, such as glue, and edges of the front face are coated with the substance so that a pocket is formed for receiving the photo 100. If the rear body 32 is rectangular, then three of the four sides contain the substance.

The windowpane 60 is placed against the front face of the rear body 32 so that the fastener permanently connects the windowpane 60 thereto. Thus, the pocket 62 is formed for receiving the print 100. If the windowpane 60 is not desired, the front body 34 replaces the windowpane 60 and is, therefore, permanently connected to the rear body 32 to form the pocket 62 therebetween.

If the windowpane 60 is present, the front body 34 and the removable part 37 are connected to the windowpane 60 with at least the removable part 37 being non-permanently connected thereto. Thus, when the removable part 37 is removed, the front body 34 forms a frame around the print 100 located inside the pocket 62.

A fastener (e.g., an adhesive or a chemical substance) is also placed on the opening side 39 of the rear body 32. This fastener is covered with the pull-off tab 70 before the front body 34 or the windowpane 60 is permanently connected to the rear body 32 so that removal of the pull-off tab 70 controls activation of the fastener.

After the pocket 62 is formed and after the print 100 is placed in the pocket 62, the user has the ability to seal the print 100 inside the pocket 62 merely by removing the pull-off tab 70 and allowing the fastener at the opening side 39 to fasten to at least one of the front body 34 and/or the windowpane 60.

To display the print 100 from the front side 35 of the front body 34, the print 100 is placed between the rear and front bodies 32, 34 (if the windowpane 60 is not present) or between the rear body 32 and the windowpane 60 and the removable part 37 is removed.

By adopting the at least two-layer construction described above, the flaps 40, 42 may be folded out from the rear of the postcard 30 without disturbing the print 100 located in the pocket 62. Similarly, the two-layer construction permits the flaps 40, 42 to be folded out from the rear body 32 without disturbing any fastening connection between the rear body 32 and at least one of the front body 34 or the windowpane 60.

I claim:

1. A postcard, comprising:
a generally planar rear body having:
a front face;
a rear face;
at least two edges; and
a stand extendible from said rear face to permit said rear body to be stood on either of said edges;
a generally planar front body having a forward face, a reverse face, at least two edges, and a removable part;
said rear body and said front body being connected together to define a pocket therebetween for receiving and holding a third planar body therein, the third planar body being smaller than at least one of said rear body and said front body; and
said front body defining a window for viewing the third planar body when said removable part is at least partially removed from said front body.

2. The postcard according to claim 1, wherein said stand has two flaps defined in said rear face by lines of weakness formed in said rear face, two of said lines of weakness forming fold lines for folding at least one of said flaps out of a plane of said rear body to form a respective extending portion upon which said rear body rests when said rear body is stood on one of said edges

3. The postcard according to claim 2, wherein said two flaps are two triangular flaps, each of said triangular flaps folding to form a respective one of said extending portions for standing at least said rear body on one of said edges.

4. The postcard according to claim 1, further comprising an at least partially transparent, generally planar window body disposed between said front and rear bodies for protecting the third planar body disposed between said front and rear bodies from the environment.

5. The postcard according to claim 1, wherein said window body is connected to said reverse face of said front body to form a protective enclosure at said window.

6. The postcard according to claim 1, wherein said rear face has a first portion for positioning thereon a postal address and a second portion for receiving a message thereon.

7. The postcard according to claim 2, wherein said flaps are coextensive with said first portion.

8. The postcard according to claim 2, wherein said flaps have a common line of weakness.

9. The postcard according to claim 4, wherein said removable part is an entirely separate part from a remainder of said front body, is located in said front body, and is removably connected to said windowpane.

10. The postcard according to claim 1, wherein said removable part is connected to said front body in a breakable connection.

11. The postcard according to claim 10, wherein said removable part has breaking tabs removably connecting said removable part to said front body.

12. The postcard according to claim 11, wherein said breaking tabs are 8 breaking tabs.

13. The postcard according to claim 1, wherein said removable part is, when removed, an advertisement.

14. The postcard according to claim 1, wherein said removable part is, when removed, a coupon.

15. The postcard according to claim 1, wherein said removable part is, when removed, a single-sheet postcard.

16. The postcard according to claim 1, further comprising a perfume sample holding device connected to at least one of said rear body, said front body, and said removable part.

17. The postcard according to claim 16, wherein said perfume sample holding device has a removable tab that, when removed, exposes a perfume sample to the environment.

18. A postcard, comprising:
a generally planar rear body;
a generally planar front body having a removable part, said front body being connected to said rear body to define a pocket therebetween for receiving and holding a third planar body therein, the third planar body being smaller than at least one of said rear body and said front body; and
said front body defining a window for viewing the third planar body when said removable part is at least partially removed from said front body.

19. A postcard, comprising:
a generally planar rear body;
a generally planar front body having a removable part, said front body being connected to said rear body to define a pocket therebetween for receiving and holding a third planar body therein, the third planar body being smaller than at least one of said rear body and said front body;
said front body defining a window for viewing the third planar body when said removable part is at least partially removed from said front body; and
an at least partially transparent, generally planar window body disposed between said front and rear bodies for protecting the third planar body disposed between said front and rear bodies from the environment.

20. The postcard according to claim 19, wherein:
said front body has a rear face; and
said window body is connected to said rear face to form a protective enclosure at said window.
